(19) United States
(12) Patent Application Publication
(10) Pub. No.: US 2010/0111488 A1
(43) Pub. Date: May 6, 2010

(54) Systems and Methods Of Quality Control In A Video Playback Device

(75) Inventor: Kuo Chia-Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CYBERLINK CORPORATION, Taipei (TW)

(21) Appl. No.: 12/262,598

(22) Filed: Oct. 31, 2008

(51) Int. Cl. H04N 5/76

(52) U.S. Cl. 386/46; 386/E05.001

(57) ABSTRACT

Systems and methods for quality control in video playback device are provided that provide a quality control method for a video playback device with a power supply unit and a video processing unit for playback when the power supply unit supplies power thereto. The power supply of the video playback device may not always provide full performance. An insufficient power supply may result in video jitters or dropped frames. Disclosed methods of quality control in a video playback device may achieve smooth playback under varying power performance.

### TECHNICAL FIELD

The present disclosure is generally related to electronics and, more particularly, is related to portable video devices.

### BACKGROUND

Video playback devices have proliferated to become almost conventional eponymous electronic devices. Increased efficiency of battery powered devices has contributed to this proliferation. Portable video players were created in order to aid the ability to watch videos, namely DVDs, away from home. They are practical for on the go use, and many perform secondary functions such as playing music.

Portable DVD players that are capable of playing DVDs. Most have an LCD screen and stereo speakers and are usually powered by lithium ion batteries. Portable DVD players are often used for long road trips and travel.

A portable multimedia player (PMP), sometimes referred to as a portable video player (PVP), is a consumer electronics device that is capable of storing and playing digital media. Digital audio players (DAP) that can also display images and play videos are PMPs. Like DAPs, the data is typically stored on a hard drive, microdrive, or flash memory. Other types of electronic devices such as cellphones are sometimes referred to as PMPs due to their playback capabilities.

A DVD player is a device that plays discs produced under both the DVD Video and DVD Audio technical standards, two different and incompatible standards. Most hardware DVD players have to be connected to a television set; there are also some small portable devices which have an LCD screen attached. Software DVD players are programs that allow users to view DVD videos on a computer with a DVD-ROM drive.

### SUMMARY

Example embodiments of the present disclosure provide systems of quality control in a video playback device. Briefly described, in architecture, one example embodiment of the system, among others, can be implemented as follows: a battery; a video display; memory configured to store video processing software; and a video processor configured to determine if a power status is sufficient for smooth playback of the video content on the video display; and if the power status is not sufficient for smooth playback, adjust a performance parameter by turning off a special playback effect of the video playback system until smooth playback of the video content can be achieved from a current power level, reflected by the power status.

Embodiments of the present disclosure can also be viewed as providing methods for quality control in a video playback device. In this regard, one embodiment of such a method, among others, can be broadly summarized by the following: monitoring a power status of a video playback device; determining if the power status is sufficient for smooth playback; and if the power status is not sufficient for smooth playback, reducing an output performance parameter until smooth playback can be achieved from a current power level, reflected by the power status; wherein reducing an output performance parameter comprises turning off a special playback effect of the video playback device.

### BRIEF DESCRIPTION OF THE DRAWINGS

FIG. 1 is a diagram of an example embodiment of a video playback device.

FIG. 2 is a flow diagram of an example embodiment of a method of quality control in the video playback device of FIG. 1.

FIG. 3 is a diagram of example embodiments of the method of quality control in a video playback device of FIG. 2.

FIG. 4 is a diagram of example embodiments of the method of quality control in a video playback device of FIG. 2.

FIG. 5 is a diagram of example embodiments of the method of quality control in a video playback device of FIG. 2.

FIG. 6 is a diagram of example embodiments of the method of quality control in a video playback device of FIG. 2.

FIG. 7 is a flow diagram of an example embodiment of a method of quality control in the video playback device of FIG. 1.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Many embodiments of video players are compatible with the MP3 audio format, and many others support Windows Media Audio (WMA), Advanced Audio Coding (AAC) and/or WAV. Audio files purchased from online stores or ripped from CDs may include DRM copy protection, which most modern players support. Some players are compatible with open-source formats such as Ogg Vorbis and the Free Lossless Audio Codec (FLAC). Devices typically have a bitrate limit on each compatible format. Most newer players support the MPEG-4 video format, and many other players are compatible with Windows Media Video (WMV) and the defunct AVI, now mostly used as a container format. Recently, more and more players are enabling compatibility to the DivX video format and its open-source parallel, Xvid. Software included with the players may be able to convert video files into a compatible format. As with DAPs, PMPs may come in flash or hard disk storage, among others.

A number of players support memory card slots, including CompactFlash (CF), Secure Digital (SD), and Memory Sticks. They are used to directly transfer content from external devices, and expanding the storage capacity of PMPs. A standard PMP may use a 5-way D-pad to navigate, however there have been many alternatives used. Most notable are the wheel and touch mechanisms seen on players from the iPod and Sansa series. Additional buttons are commonly seen for features such as volume control.

As needed for video and photo functions, all PMPs are equipped with display screens. Resolutions may vary, going up to WVGA. Many screens may come with a color depth of 16-bit, but higher quality video oriented devices may range all the way to 24-bit, otherwise known as Truecolor, with the ability to display 16.7 million distinct colors. Touch screen may be implemented as a form of primary or alternate input. This can be for convenience and/or aesthetic purposes.

As one example of a video playback system, a DVD player may complete a number of tasks, including:
reading a DVD disc in ISO—UDF format;
decrypting the data with either CSS and/or Macrovision;
reading and obeying the DVD's regional lockout codes and displaying a warning if the player is not authorized to play the DVD;
decoding the MPEG-2 video stream with a maximum of 10 Mbit/s (peak) or 8 Mbit/s (continuous), as an example;
decoding sound in MP2, PCM or AC-3 format and outputting (with optional AC-3 to stereo downsampling) through a stereo, optical or electric digital connector; and
outputting a video signal, either analog (in NTSC, PAL or SECAM format) on a composite, S-Video, SCART, or component video connector, or digital on an DVI or HDMI connector.

Example embodiments of systems and methods of quality control in video playback device disclosed herein provide a quality control method for a video playback device with a power supply unit and a video processing unit for playback when the power supply unit supplies power thereto. Due to issues related to portability, energy footprint, and heat generation, among others years, consumer electronics manufactures have addressed concerns related to energy saving. Many energy saving techniques are achieved by reducing the computing power such as the operating frequency of the semiconductor chipsets.

CyberLink TrueTheater™ is an advanced technology which needs nearly as much power as playing a Blu-ray title (both of them are high definition or more—at 24 frames per second or more). A high-end platform implementing energy saving techniques may still suffer from playback that is not smooth due to the downgrading of the computing power. CyberLink TrueTheater™ is a post-processing technology which implements color adjustment, sharpening, noise reduction, aspect ratio conversion, and resolution up-conversion, as well as frame rate up-conversion. Example embodiments of methods and systems of quality control in a video payback device as disclosed herein may detect the computing power requirement for a particular playback technology, such as CyberLink TrueTheater™, and modify the post-processing strategy dynamically by enabling or disabling at least one of the components of CyberLink TrueTheater™ to achieve a smooth playback under critical cases.

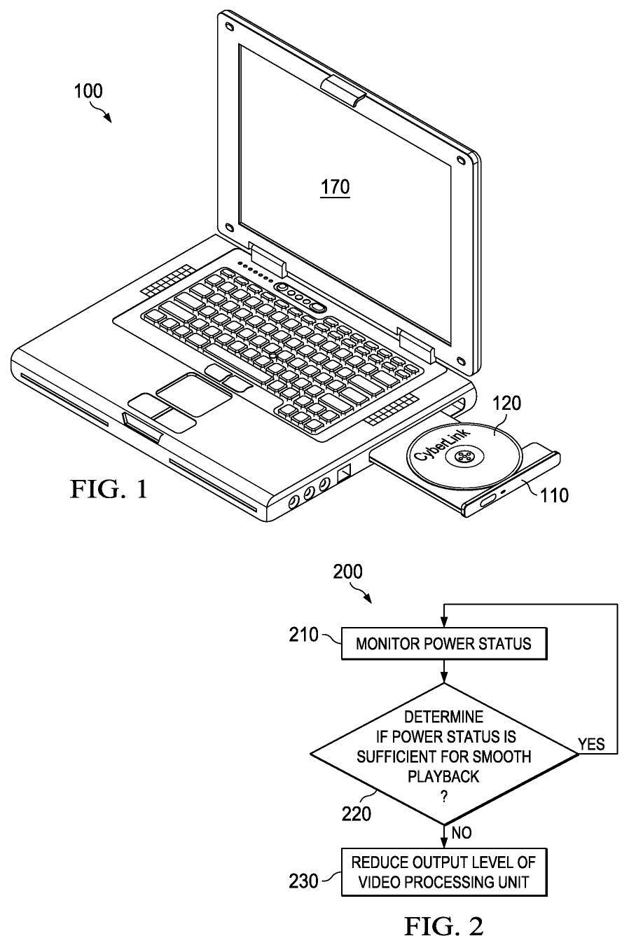

An example embodiment of a video playback device is provided in FIG.1. Video playback device 100 may include display 170, media tray 110, and media storage device 120. Media storage device 120 is depicted as a CD-ROM or a DVD, but media may also be stored on other non-limiting devices such as system memory, flash card, flash drive, floppy drive, internal hard drive, and external hard drive. The media may also be provided over a network connection, either stored remotely, or provided in a streaming capacity. Software for performing example embodiments of methods of quality control in video playback device 100 may be stored in a computer readable medium. The software may be run on a processing device in the video playback device. The power supply of video playback device 100 may not always provide full performance. An insufficient power supply may result in video jitters or dropped frames. Disclosed methods of quality control in a video playback device may achieve smooth playback under varying power performance.

As provided in flow chart 200 of FIG. 2, example embodiments of a method of quality control in video playback device 100 may include three steps. In block 210, the power status is monitored. In block 220, the power status is examined to determine whether the power status is sufficient for smooth playback. A special playback effect may use more power to achieve that effect. By causing more power to be consumed, the playback processing may be effectively starved for power such that smooth playback cannot be achieved. A non-limiting example of playback that is not smooth is a case in which at least 5 percent of the video frames are dropped. In block 230, based on the determination in block 220, for example, that more than 5 percent of the video frames are dropped, the output level of the video processing unit is reduced, or, alternatively, the special playback function is turned off, so that smooth playback may be accomplished.

For a particular video playback device or system, a predetermined power profile may be determined that establishes a minimum power level for maintaining smooth playback. The power profile may be set as a default level in a factory, may be learned during operation, or may be set by a user, as non-limiting examples. The power profile may include battery-life as a factor.

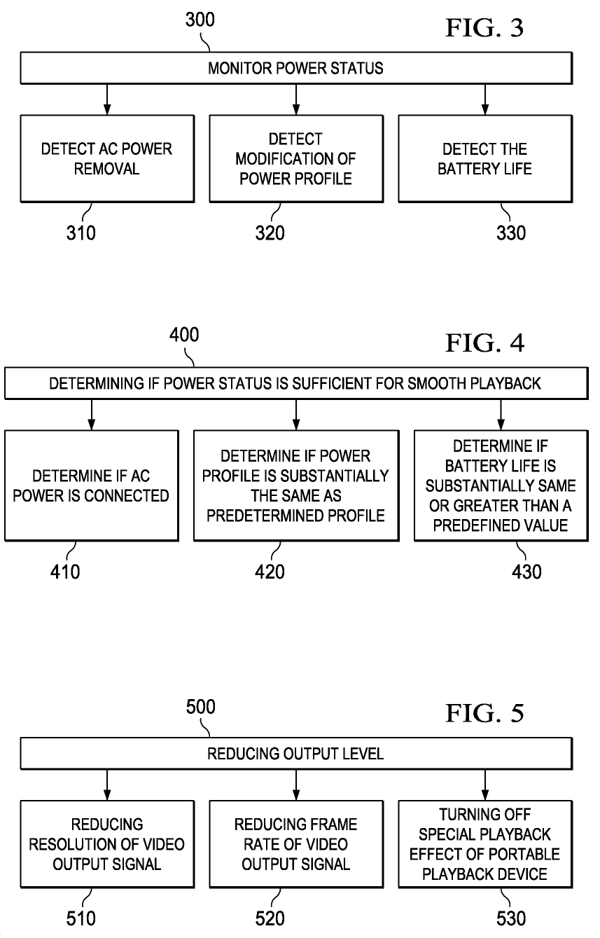

As provided in FIG. 3, monitoring the power status 300 may be achieved by at least one of the following techniques: detect AC power removal 310; detect modification of the power profile 320; and detect the remaining battery life 330.

As provided in FIG. 4, the determination of whether the power status is sufficient for smooth playback 400 may be achieved by at least one of the following techniques: determining whether AC power is connected 410; determining whether the power profile is substantially the same as a predefined profile 420; and determining whether the battery life is higher than a predefined value 430.

In an example embodiment, the event of AC power removal is monitored. If video playback device 100 is now powered by a battery instead of AC power line, the output level of the video processing unit will be reduced. As provided in FIG. 5, reduction of an output level of a video output signal 500 may be achieved by at least one of the following techniques: reducing the resolution of the video output signal 510, reducing the frame rate of the video output signal 520, and turning off at least one special playback effect of video playback device (100) 530. The special playback effect may include, as non-limiting examples, color adjustment and resolution conversion. Reduction of an output level of a video output signal 500 may decrease the complexity and power consumption of the video processing and enable smooth playback.

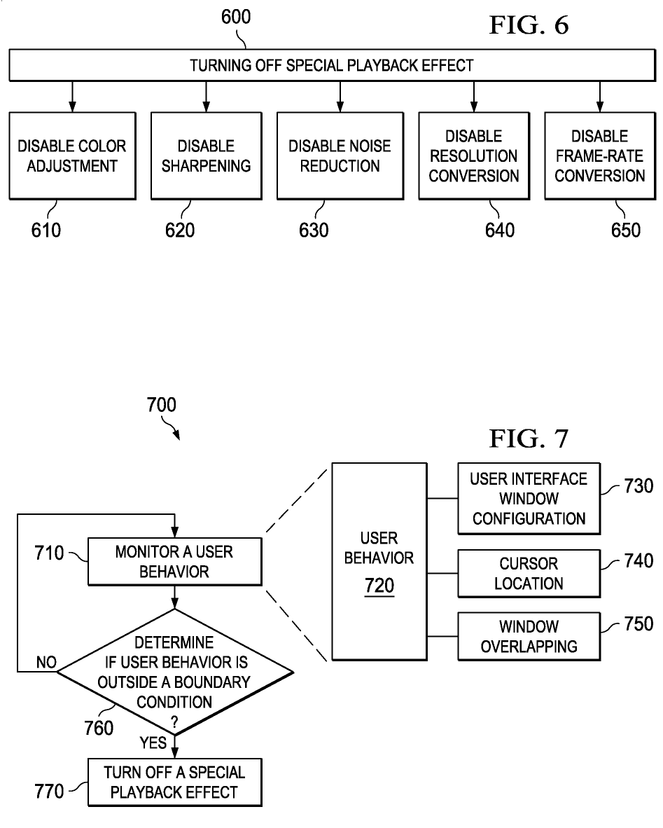

As provided in FIG. 6, turning off a special playback effect 600 of video playback device 100 may be achieved by at least one of the following techniques: disabling the capability of color adjustment 610; disabling the capability of sharpening 620; disabling the capability of noise reduction 630; disabling the capability of resolution up-conversion 640; disabling the capability of frame-rate conversion 650 and disabling an aspect ratio conversion. An aspect ratio conversion may be performed by, for example, non-linear resizing, such as adjusting an aspect ratio from 4:3 to 16:9. Disabling the capability of resolution up-conversion 640 and disabling the capability of frame-rate up-conversion 650 may be achieved by returning to an original resolution/frame rate. A resolution up-conversion operation includes an operation which results in an output resolution that is greater than an input resolution. A frame rate up-conversion operation includes an operation in which the output frame rate is greater than the input frame rate.

In an example embodiment, as provided in flow diagram 700 of FIG. 7, other behaviors may also be monitored and adjusted to reduce power consumption, thereby extending battery life and extending the time that smooth playback is available. In block 710, user behavior 720 is monitored. Non-limiting examples of user behavior 720 include user interface window configuration 730, cursor location 740, and window overlapping 750. In block 760, a determination of whether user behavior 720 is outside of a boundary condition. For example, a determination is made as to whether the user interface window configuration is smaller than a predetermined size. If, in block 760, the user behavior is determined to not be outside of a boundary condition, the user behavior is again monitored in block 710. For example, if, in block 760, the user interface window configuration is not smaller than a predetermined size, the user behavior is again monitored.

However, if, in block 760, the user interface window configuration is determined to not be smaller than a predetermined size, in block 770, the special effect may be turned off to reduce power consumption the boundary condition. In other examples, if the cursor location is on an area other than the playback device or is clicking on another program, the special effect may be turned off to reduce power consumption. If the playback window is overlapped by other windows/programs, the special effect may be turned off to reduce power consumption. These non-limiting example embodiments may have a direct effect of reducing power consumption and an indirect, little, or no effect on smooth playback.

The flow chart of FIG. 2 shows the architecture, functionality, and operation of a possible implementation of quality control software in a video playback device. In this regard, each block represents a module, segment, or portion of code, which comprises one or more executable instructions for implementing the specified logical function(s). It should also be noted that in some alternative implementations, the functions noted in the blocks may occur out of the order noted in FIG. 2. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Therefore, at least the following is claimed:

1. A method for quality control in a video playback device comprising:
monitoring a power status of a video playback device;
determining if the power status is sufficient for smooth playback; and
if the power status is not sufficient for smooth playback, reducing an output performance parameter until smooth playback can be achieved from a current power level, reflected by the power status; wherein reducing an output performance parameter comprises turning off a special playback effect of the video playback device.

2. The method of claim 1, wherein the power status is monitored by detecting at least one of:
AC power removal from the video playback device;
modification of a power profile of the video playback device; and
a capacity of a battery of the video playback device.

3. The method of claim 1, wherein determining if the power status is sufficient for smooth playback comprises at least one of:
determining if AC power is connected to the video playback device;
determining if a power profile of the video playback device is substantially the same as a predetermined profile; and
determining if a life of a battery of the video playback device is substantially the same or greater than a predefined value.

4. The method of claim 1, wherein reducing an output performance parameter further comprises at least one of:
reducing a resolution of a video output signal of the video playback device; and
reducing a frame rate of a video output signal of the video playback device.

5. The method of claim 1, wherein turning off a special playback effect comprises at least one of:
disabling a color adjustment of a video output of the video playback device;
disabling a sharpening of a video output of the video playback device;
disabling a noise reduction of a video output of the video playback device;
disabling a resolution up-conversion of a video output of the video playback device;
disabling a frame-rate up-conversion of a video output of the video playback device; and
disabling an aspect ratio conversion of a video output of the video playback device.

6. The method of claim 5, wherein disabling the resolution up-conversion comprises returning to an original video output resolution.

7. The method of claim 5, wherein disabling the frame-rate up-conversion comprises returning to an original video output frame-rate.

8. The method of claim 5, further comprising monitoring a user behavior and turning off a special effect based on the user behavior, wherein the user behavior comprises at least one of a user interface window configuration, a cursor location, and window overlapping.

9. A computer readable medium comprising:
logic configured for monitoring a power status of a video playback device;
logic configured for determining if the power status is sufficient for smooth playback; and
logic configured for, if the power status is not sufficient for smooth playback, reducing an output performance parameter until smooth playback can be achieved from a current power level, reflected by the power status; wherein reducing the output performance parameter comprises turning off a special playback effect of the video playback device.

10. The computer readable medium of claim 9, wherein logic configured for monitoring a power status further comprises logic configured for detecting at least one of:
AC power removal from the video playback device;
modification of a power profile of the video playback device; and
a capacity of a battery of the video playback device

11. The computer readable medium of claim 9, wherein logic configured for determining if the power status is sufficient for smooth playback comprises at least one of:
logic configured for determining if AC power is connected to the video playback device;
logic configured for determining if a power profile of the video playback device is substantially the same as a predetermined profile; and
logic configured for determining if a life of a battery of the video playback device is substantially the same or greater than a predefined value.

12. The computer readable medium of claim 9, wherein logic configured for reducing an output performance parameter further comprises logic configured for at least one of:
reducing a resolution of a video output signal of the video playback device; and
reducing a frame rate of a video output signal of the video playback device.

13. The computer readable medium of claim 9, wherein logic configured for turning off a special playback effect comprises logic configured for at least one of:
disabling a color adjustment of a video output of the video playback device;
disabling a sharpening of a video output of the video playback device;
disabling a noise reduction of a video output of the video playback device;
disabling a resolution up-conversion of a video output of the video playback device; and
disabling a frame-rate up-conversion of a video output of the video playback device.

14. The computer readable medium of claim 13, wherein logic configured for disabling the resolution up-conversion comprises logic configured for returning to an original video output resolution.

15. The computer readable medium of claim 13, wherein logic configured for disabling the frame-rate up-conversion comprises logic configured for returning to an original video output frame-rate.

16. The computer readable medium of claim 9, further comprising logic configured for monitoring a user behavior and turning off a special effect based on the user behavior, wherein the user behavior comprises at least one of a user interface window configuration, a cursor location, and window overlapping.

17. A video playback system for displaying video content, the system comprising:
a battery;
a video display;
memory configured to store video processing software; and
a video processor configured to
determine if a power status is sufficient for smooth playback of the video content on the video display; and
if the power status is not sufficient for smooth playback, adjust a performance parameter by turning off a special playback effect of the video playback system until smooth playback of the video content can be achieved from a current power level, reflected by the power status.

18. The video playback system of claim 17, wherein the video processor determines if the power status is sufficient for smooth playback by at least one of:
determining if AC power is connected to the video playback system;
determining if a power profile of the video playback system is substantially the same as a predetermined profile; and
determining if a capacity of the battery of the video playback system is substantially the same or greater than a predefined value.

19. The video playback system of claim 17, wherein the video processor further adjusts the performance parameter by at least one of:
reducing a resolution of a video output signal of the video playback system; and
reducing a frame rate of a video output signal of the video playback system.

20. The video playback system of claim 17, wherein turning off a special playback effect comprises at least one of:
disabling a color adjustment of the video content of the video playback system;
disabling a sharpening of the video content of the video playback system;
disabling a noise reduction of the video content of the video playback system;
disabling a resolution up-conversion of the video content of the video playback system; and
disabling a frame-rate up-conversion of the video content of the video playback system.

21. The video playback system of claim 20, wherein disabling the resolution up-conversion comprises returning to an original video output resolution.

22. The video playback system of claim 20, wherein disabling the frame-rate up-conversion comprises returning to an original video output frame-rate.

23. The video playback system of claim 17, wherein the video processor is further configured to monitor a user behavior and turn off a special effect based on the user behavior, wherein the user behavior comprises at least one of a user interface window configuration, a cursor location, and window overlapping.
